(19) United States
(12) Patent Application Publication
(10) Pub. No.: US 2013/0186709 A1
(43) Pub. Date: Jul. 25, 2013

(54) Retractable Step Stool/ Access Device

(71) Applicant: Ralph Layne White, North Little Rock, AR (US)

(72) Inventor: Ralph Layne White, North Little Rock, AR (US)

(21) Appl. No.: 13/707,900

(22) Filed: Dec. 7, 2012

(51) Int. Cl. A47C 12/00; E06C 9/06

(52) U.S. Cl. CPC A47C 12/00; E06C 9/06
USPC 182/89; 182/91

(57) ABSTRACT

The present invention is for a step stool to be used by a child, diminutive person or an adult of average height to gain vertical reach. The retractable step stool/access device is positioned by one's foot between an elevated, retracted position or a lowered, deployed step accessible position. Internal stored energy mechanisms can be employed to ease some of the physical effort required, especially by a child or diminutive person, to complete the deployment/retraction cycle with either of their feet. In the raised, retracted position, the step stool is elevated from contact with the floor and clear of the standing area for general usage and allowing access for cleaning and maintenance of the floor.

### BACKGROUND OF THE INVENTION

1. Field of the Invention

This invention was conceived as an improvement over prior art apparatus and methods for stowable, deployable, step stools which the user can selectively position in a raised or retracted/stored position or in a lowered or extended step accessible position. Relevant prior art to this invention is found in U.S. Patent Class 182, subclass 91.

2. Description of the Related Art

Presently there are step stools of various configurations in the public domain as well as patented step stool type devices for allowing access to items, articles, and devices that are beyond vertical reach of certain persons such as children and adults of small stature and/or lesser height than the average adult. One common form of step stool is a one piece box like structure or a platform with short legs for giving a person a one step height advantage over just standing on the floor. Use is accomplished by locating the step stool in its stored location and moving and positioning it on the floor below the area to be accessed. The user then steps on the step stool thereby gaining the extra vertical reach required to retrieve an item or access a device. The user, when finished, steps off the step stool and normally moves it back to its original stored position. Such step stools are not limited to a box like structure of square or rectangular shape but can be round or oval or of odd shapes as long as a horizontal step area is provided and legs or side structure is provided that yields a stable platform on which to stand thereby gaining an extra height/reach advantage. The use and deployment of such a simple step stool normally requires the user to physically bend down and grasp the step stool with one's hands, lift it and position it in the desired location of use. Then after use again grasp the step stool, lifting it and returning it to its place of storage. A favored use of a step stool for a child is for gaining a height advantage at the bathroom lavatory for washing and grooming. This is so in the place of residence but also at public facilities. Both present a sanitation issue since after the person has washed up and stepped off the step stool and then grasps the step stool and returns it to its stored location they have again soiled their hands, but now cannot reach the sink to wash them again. This situation needs a remedy. A convenient place for storing the step stool is under the sink or in or about the sink/lavatory cabinetry. The prior art has attempted to address this situation by various means. Such means have taken the forms of steps that's hinged to a structure so that the step can be folded out into position and after use be repositioned to the stored position by folding the step back. Others seek to accomplish this by deployment and restoring by use of a sliding mechanism.

Both U.S. Pat. No. 8,037,557 to Sumpton et al (2011) and U.S. Pat. No. 5,131,492 to Caminiti (1992) show repositional steps manually actuated by the user. Both of these patents show the ability to be disposed in a stored configuration or access configuration. U.S. Pat. No. 8,037,557 to Sumpton (2011) provides a sink access device which has a top step platform pivotally attached to a base. The base is secured to the floor with the step platform able to be positioned in a vertical, stored position or a horizontal step accessible position. The Sumpton patent device is mechanically fastened to the floor beneath a sink or lavatory to provide a step platform for a child or other diminutive person to reach the sink. The Sumpton patent device is meant to be used in conjunction with a sink exclusively. The Sumpton device cannot be installed inside of any enclosure such as cabinetry and the base is mounted at floor level only. The base cannot be relocated to facilitate the cleaning of the floor and no component for storage of loose items is provided.

U.S. Pat. No. 5,131,492 to Caminiti provides a collapsible folding step-stool which is mountable to a cabinet door. The step stool has a bracket mountable to a cabinet door and a step platform. The platform may be lowered from a raised vertical stored orientation to a horizontal operative position in which the platform is supported by four legs which contact and rest upon the floor. A plurality of parallel arms pivotally couple the step platform to a U-shaped member which is in turn mounted to the cabinet door. The step platform is manually raised from a horizontal operative position to a vertical stored orientation disposed within the U-shaped channel. The pivotally coupled four legs collapse and fold to a position within the U-shaped channel secured to the cabinet door. In the Caminiti patent the platform must be repositioned manually thereby requiring the use of the hands. The device cannot be stored within an enclosure like a bathroom or kitchen cabinet and provides no storage tray for loose items. Further, the user must bend down and manually lock the step platform in the vertical stored orientation within the U-shaped channel.

In conclusion, I am aware of no easily deployable step access assembly which can be readily lowered from a stored, raised position to a lowered step accessible position without using the hands. Ideally a step access assembly for a child or small person should remain in a position horizontal to the floor while being positioned for step access. This would remove the need to position the platform manually from a vertical stored orientation to a horizontal lowered position to provide the needed gain in vertical reach required by the user without contaminating their hands. Furthermore, I am aware of no such deployable step access assembly which provides a storage tray for loose items while also facilitating ease of floor maintenance and cleaning.

### BRIEF SUMMARY OF THE PRESENT INVENTION

The invention, an improved retractable step stool/access device, is made from rigid materials. The device can be lowered from a retracted, stored position to a lowered, deployed step accessible position by the user's foot. The retractable step stools upper step platform remains positioned horizontal to the floor throughout the deployment/retraction cycle. Internal stored energy mechanisms provide assistance to a user, especially small children, for ease of vertically repositioning the device to the retracted position podiatrically. Accordingly, a fundamental object of the invention is to provide a retractable Step stool to be utilized by a diminutive person to gain desired vertical reach. Another basic object is to provide a quickly deployable and retractable step stool to be utilized in several applications where extra vertical reach height is required. It is also an object to allow operation of the retractable step stool/access device by not requiring the user to manually engage the device. Further, an important object is to require operation of the device to be accomplished by use of the users feet only. Another object is to provide a storage tray for the containment of loose items while also facilitating ease of cleaning and maintenance of floored surfaces. Still further objects and advantages will become apparent from a study of the following description and the accompanying drawings.

### BRIEF DESCRIPTION OF THE DRAWINGS

In the following drawings, which form a part of the specification and which are to be construed in conjunction therewith, and in which like reference numerals have been employed throughout wherever possible to indicate like parts in various views:

FIG. 1 is a right side elevation view of version 1 mounted in a cabinet showing the retractable step stool/access device in a lowered deployed position.

FIG. 2 is a perspective view of version 1 mounted in a cabinet showing the retractable step stool/access device in a lowered deployed position.

FIG. 3 is a right side elevation view of version 2 mounted in a cabinet showing the retractable step stool/access device in a lowered deployed position.

FIG. 4 is a perspective view of version 2 mounted in a cabinet showing the retractable step stool/access device in a lowered deployed position.

FIG. 5 is a right side elevation view of version 3 mounted to a wall showing the retractable step stool/access device in a raised stored position.

FIG. 6 is a perspective view of version 3 mounted to a wall showing the retractable step stool/access device in a raised stored position.

FIG. 7 is a right side elevation view of version 4 mounted to the floor showing the retractable step stool/access device in a raised stored position.

FIG. 8 is a perspective view of version 4 mounted to the floor showing the retractable step stool/access device in a raised stored position.

FIG. 9 is a side elevation view showing a small person deploying/re-storing version 1-2 of the step stool/access device.

FIG. 10 is a side elevation view showing a small person deploying/re-storing version 3-4 of the step stool/access device.

### DESCRIPTION OF THE INVENTION

With reference to the drawings:

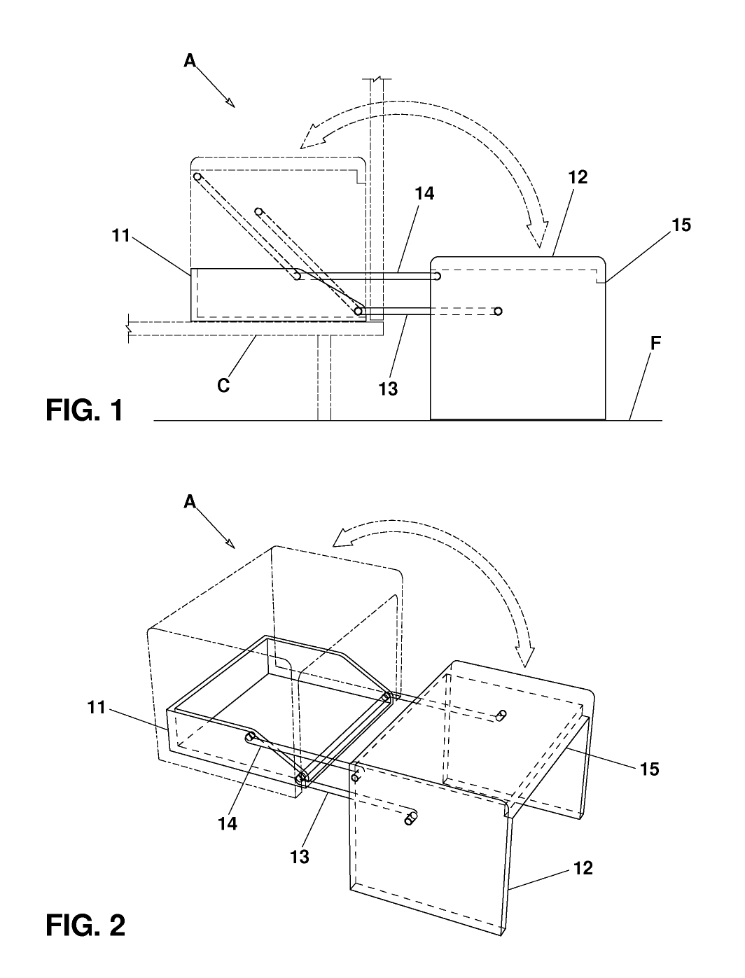

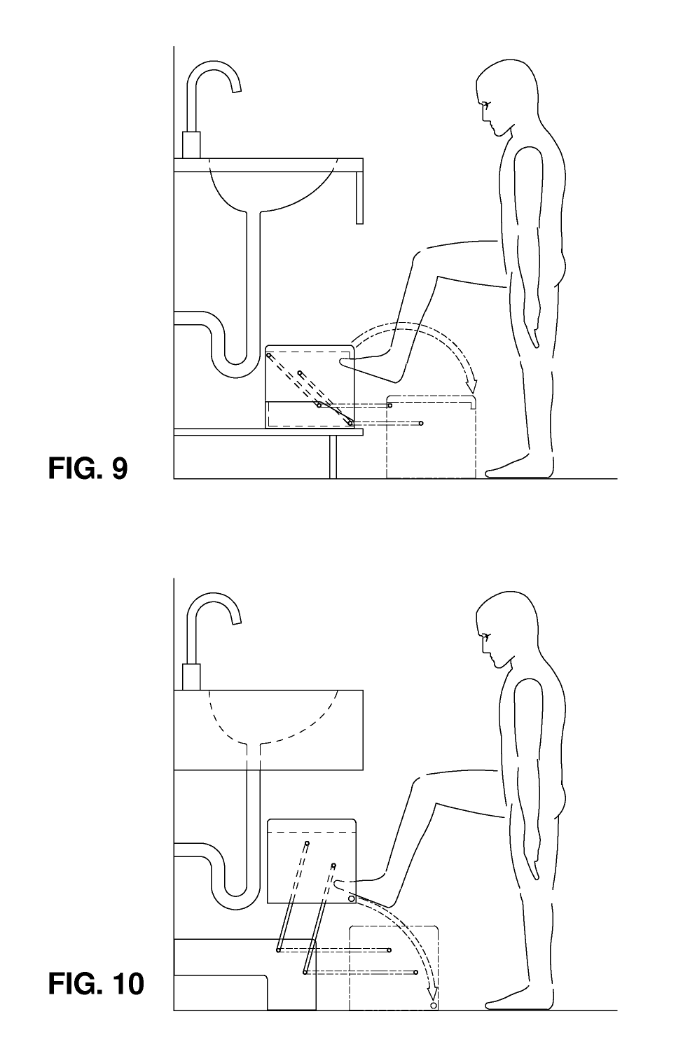

FIGS. 1 and 2 illustrate version 1 mounted within a cabinet C resting upon a floor F. The retractable step stool/access device assembly A, includes base storage tray 11 and step stool 12. Base storage tray 11 and step stool 12 are constructed of rigid material and are generally rectangular in shape. Step stool 12 has a top step platform with a down turning forward lip 15, and an open front and rear with two opposed supporting sides. Base storage tray 11 and step stool 12 are connected by means of formed rod members, lower arm 13, essentially in a U-shape, and upper arm 14, both preferably made of steel. Lower arm 13 is pivotally connected to the forward edge of base 11 with the ends of the right and left upper portions of the U-shaped arm 13 turning outward and inserting into two holes located on the interior surfaces of the opposed sides of step stool 12. The singular upper arm 14 is pivotally connected to one side of the base storage tray 11 and extends to a pivotal connection point within the interior of step stool 12. As depicted in FIG. 9, a child can, by placing the toe of the foot under lip 15 lift step stool 12 from the stored position over base storage tray 11, move step stool 12 through an arc that is guided by lower arm 13 and upper arm 14 and bring step stool 12 to rest on floor F. After using step stool 12 to gain the necessary height/reach advantage, step stool 12 is returned to the stowed position over base storage tray 11 by again using the foot.

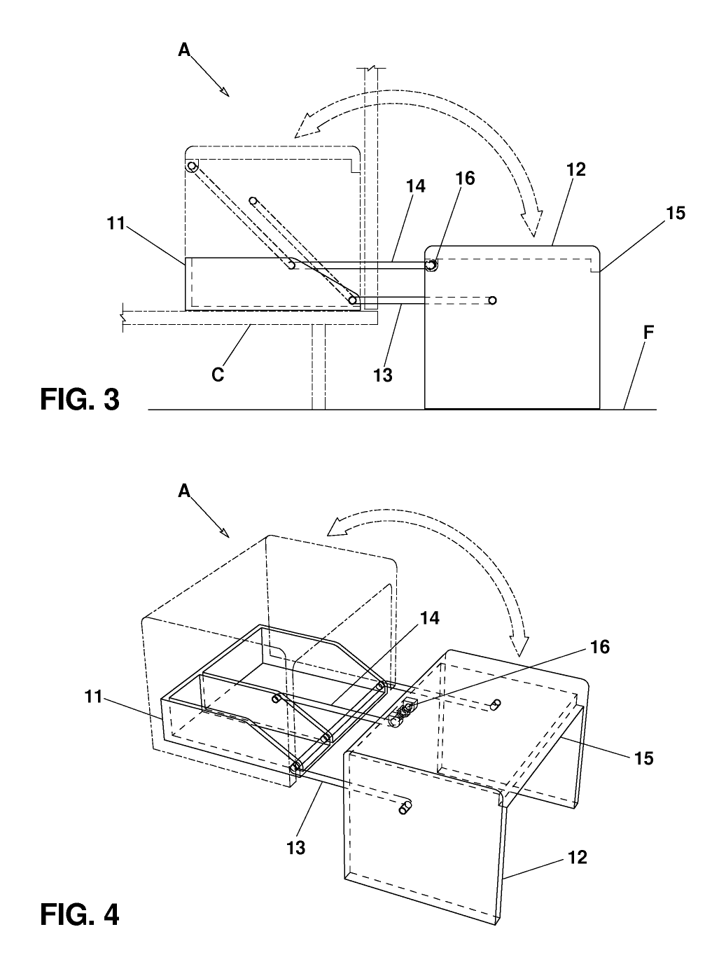

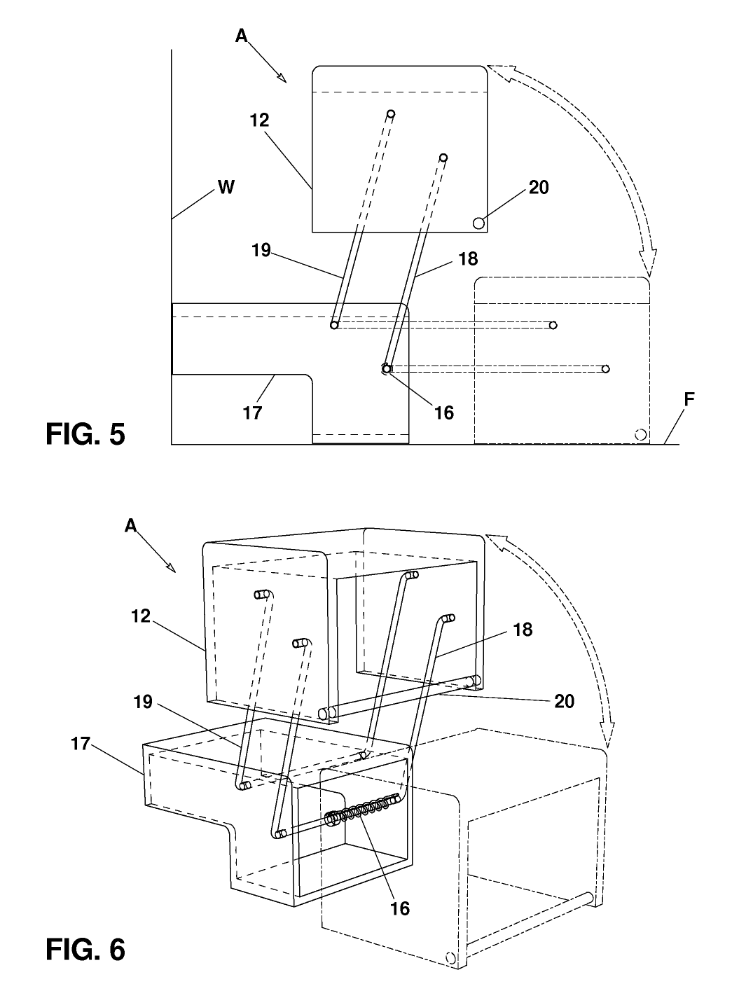

FIGS. 3 and 4 illustrate a second version of the invention. In this version positioning of the step stool 12 between the stored position and the deployed position is assisted by mechanical energy stored in torsion spring 16. Torsion spring 16 is attached underneath the top step surface of step stool 12, at the rearward edge, while also being pivotally connected to the upper arm 14 at one end with the other end of arm 14 being pivotally connected to a centrally located divider wall in the interior of the base storage tray 11. Deployment and retraction of step stool 12 is done with the foot in the same fashion as before but with less effort due to the assist from the energy stored in the torsion spring 16. FIGS. 5 and 6 show a third variation of the invention. This variant of the retractable step stool/access device assembly A is generally comprised of a step stool 12 and a hybrid base 17. The hybrid base 17 can be mounted to a floor F or mounted to an upright structural wall W. Step stool 12 is pivotally coupled to hybrid base 17 by an extended U-shaped lower arm 18 and an extended U-shaped upper arm 19. The lower sections of extended arms 18 and 19 are contained within and pass through holes located in the right and left opposed sides of hybrid base 17. The upper ends of extended arms 18 and 19 turn outboard and insert into holes located in the inside surfaces of the supporting sides of step stool 12. Step stool 12 is lowered to floor F by placing a foot upon and pressing downward on foot bar 20, which is connected to step stool 12 at the lower forward corners. Torsion spring 16 is connected to the lower portion of lower extended arm 18 to provide stored mechanical energy to lift step stool 12 to the retracted position.

As depicted in FIG. 10, a child can place a foot over bar 20 and press downward to move the stepstool to the floor F. The stepstool 12 retracts to the stowed position due to the energy stored in the torsion spring 16.

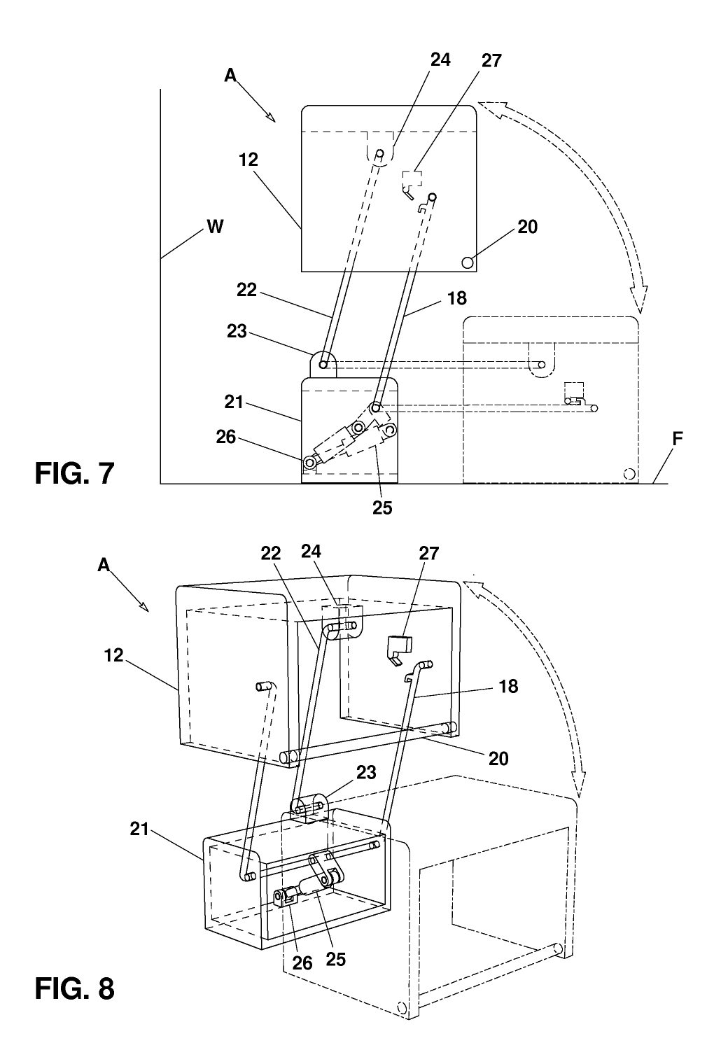

FIGS. 7 and 8 illustrate a fourth version of the invention. In this version the retractable step stool/access device assembly A is comprised generally of a step stool 12 and a floor mount base 21. The floor mount base 21 is mounted to the floor F. Step stool 12 is pivotally attached to floor base 21 by lower extended arm 18 and upper singular extended arm 22. Lower extended arm 18 is generally U-shaped with the lower segment captured within and passing through holes located in the upper forward corners of the opposing right and left sides of the floor base 21. The upper ends of the extended arm 18 bend outward and are captured within holes located on the insides of the opposed right and left supporting sides of the step stool 12. The upper singular extended arm 22 is pivotally attached at one end to a lower bracket 23 which is attached to the floor base 21 at the rearward upper edge. The opposing end of the upper singular extended arm 22 is pivotally attached to an upper bracket 24 which is attached to the underside of the top step platform of step stool 12. A gas spring 25 is pivotally attached to the lower portion of the lower extended arm 18 and to a central bracket 26 which is connected at the lower inside surface to floor base 21. Mechanical energy stored within gas spring 25 is utilized to lift the step stool 12 to a retracted or stowed position. Additionally, a latch mechanism 27 may be utilized in conjunction with the gas spring 25 that would engage when the step stool 12 is pressed to the floor allowing a child to step up onto the step stool 12 without having to continue to press it to the floor. Upon stepping up onto the step stool 12, the latch 27 would disengage so that when the child stepped off of the step stool 12, the mechanical energy of the gas spring would retract the stepstool 12 to a stowed position.

What is claimed is:

1. A deployable/retractable step stool/access device for use by persons, especially children and persons of small stature, to gain a height/reach advantage at lavatories, sinks, water fountains, cabinets, counter tops, tables, and such comprising:
a step stool step with a generally horizontal platform surface on which to stand having supporting structure for elevating the platform surface at least one step high, a separate base element with features for being retained in a fixed position by being attachable inside a cabinet, to the floor, to a wall, or by virtue of having sufficient weight, interconnecting means pivotally connected between said step stool step and said separate base element, whereby, when in the retracted stored position said step stool step is retained generally above said separate base element by said interconnecting means, so that said step stool step can be accessed by the foot and moved forward and down through an arc guided by said connecting means until said step stool step rests on the floor in the position needed to give the height/reach advantage, and thereafter, said step stool step can be returned to its original stored position by again accessing it with the foot and returning it up and back through the arc guided by said connecting means.

2. A retractable step stool/access device as in claim 1 wherein a means is incorporated storing energy for assisting in returning said step stool step to the stored position.

3. A retractable step stool/access device as in claim 2 wherein the means incorporated storing energy is a torsion spring.

4. A retractable step stool/access device as in claim 2 wherein the means incorporated storing energy is a gas spring.

5. A retractable step stool/access device as in claim 1 wherein the interconnecting means pivotally connected between said step stool step and said separate base element are rigid rods or bars which in conjunction with the step stool step and separate base element form a four bar linkage.

6. A deployable/retractable step stool/access device for use by persons, especially children and persons of small stature, to gain a height/reach advantage at lavatories, sinks, water fountains, cabinets, counter tops, tables, and such comprising:
a step stool step with a horizontal platform surface on which to stand having essentially and open front and back and having supporting sides for elevating the platform surface at least one step high, a separate base element that can be bolted or otherwise maintained in a fixed position inside a cabinet, to the floor, or to a wall, interconnecting rigid rods or bars, pivotally connected at opposite ends between said step stool step and said separate base element thereby forming a four bar linkage, whereby, when in the retracted stored position said step stool step is retained generally above said separate base element by said interconnecting rods or bars, so that said step stool step can be accessed by the foot and moved forward and down through a controlled arc being guided by said connecting rods or bars until said step stool step rests on the floor in the position needed to give the height/reach advantage, and thereafter, said step stool step can be returned to its original stored position by again accessing it with the foot and returning it up and back through the controlled arc guided by said connecting rods or bars.

7. A retractable step stool/access device as in claim 6 wherein a torsion spring is incorporated in communication between either said step stool step or said separate base element and at least one of said interconnecting rods or bars for assisting in returning said step stool step to the stored position.

8. A retractable step stool/access device as in claim 6 wherein a gas spring is incorporated in communication between either said step stool step or said separate base element and at least one of said interconnecting rods or bars for assisting in returning said step stool step to the stored position.

9. A retractable step stool/access device as in claim 7 wherein said torsion spring has incorporated with it a means for holding said step stool step in contact with, or in close proximity with, the floor to allow the user to step up onto said step stool step without having to continue to press it to the floor with said means automatically releasing/disengaging when the user steps off of said step stool allowing the mechanical energy stored in said torsion spring to return said step stool step to the stowed position.

10. A retractable step stool/access device as in claim 8 wherein said gas spring has incorporated with it a means for holding said step stool step in contact with, or in close proximity with, the floor to allow the user to step up onto said step stool step without having to continue to press it to the floor with said means automatically releasing/disengaging when the user steps off of said step stool step allowing the mechanical energy stored in said gas spring to return said step stool step to the stowed position.
